(19) United States
(12) Patent Application Publication
(10) Pub. No.: US 2010/0286856 A1
(43) Pub. Date: Nov. 11, 2010

(54) HYBRID VEHICLE WITH A BODY BUILDER EQUIPMENT CIRCUIT AND BATTERY SET

(75) Inventors: Philippe Le Brusq, Lyon (FR); Michaël Millet, La Motte Servolex (FR); Michel Mottier, Saint Bonnet de Mure (FR); Richard Valayer, Genas (FR)

Correspondence Address: WRB-IP LLP, 801 N. Pitt Street, Suite 123, ALEXANDRIA, VA, 22314, US

(73) Assignee: Renault Trucks, Saint Priest (FR)

(21) Appl. No.: 12/810,303

(22) PCT Filed: Dec. 31, 2007
(86) PCT No.: PCT/IB2007/004476

§ 371 Date: Jun. 23, 2010

(51) Int. Cl. G06F 19/00; B60K 6/42

(52) U.S. Cl. 701/22; 180/65.22; 180/65.21

(57) ABSTRACT

A hybrid vehicle includes:
an equipment circuit adapted to provide electricity to at least a body builder electrical equipment and including a equipment battery set which includes at least an equipment battery;
a equipment battery set sensor adapted to provide at least a state of charge of the equipment battery set;
an equipment converter which interconnects the equipment circuit and the driving circuit, and which is adapted to transfer electrical energy from the driving circuit to the equipment circuit;
a body builder interface and controller which controls the equipment converter so as to provide energy to the equipment circuit according to at least the state of the drive system as provided by the drive system control unit.

### BACKGROUND AND SUMMARY

The invention is directed to hybrid vehicles comprising an internal combustion engine as well as an electric drive motor, the electric drive motor and the combustion engine being used alternatively or in conjunction for driving the vehicle. While running, the internal combustion engine drives an electric generator providing electricity which can be used for charging a driving battery set. This kind of vehicle is used for many applications such as personal cars or commercial vehicles or trucks.

On commercial vehicles and trucks, it is often needed to provide power to bodybuilder equipments. Indeed, such vehicles are often provided by the vehicle manufacturers as only a chassis equipped with a driver's cabin and with the driveline and powertrain. Such chassis is to be equipped by so-called body builders with various bodies or more generally with various equipments specifically suited for a defined application. Body builder equipment can include various types and forms of cargo areas which can include various tools and equipments. Some of these tools and equipments need energy to operate. Such equipment include powered tailgates, tippable platforms, cranes and hoists, concrete mixers, garbage compactors, etc. . . . The energy needed to power such equipment is quite high, so that in conventional vehicles, it cannot be provided by the conventional on-board electric circuit and is necessarily provided through a mechanical power take-off powered by the internal combustion engine.

In a hybrid vehicle, this energy can be provided in a mechanical or electrical form. If the electrical form is chosen, this electric energy may be derived from the driving circuit and the driving battery set. The main drawback of such derivation is that the bodybuilder equipment might lower the state of charge of the driving battery under an acceptable value so that the internal combustion engine has to be used very often to recharge the driving battery. Furthermore, the nominal voltage of the driving battery is not always adapted to the voltage required by the bodybuilder equipment. Therefore, the need appears for a new kind of hybrid vehicle able to provide electrical energy or power to a body builder equipment in a very efficient way in order to keep all the advantages of a hybrid vehicle in terms of fuel consumption as well as of atmospheric and noise pollution.

In order to achieve this, the invention concerns a hybrid vehicle comprising:
a drive system comprising at least:
   an internal combustion engine unit;
   an electric motor which is connected to a driving circuit comprising a driving battery set which comprises at least one driving battery;
   a service circuit providing electricity at least to the engine unit, the service circuit comprising a service battery set which comprises at least one service battery;
   a drive system control unit providing at least a state of the drive system;
an equipment circuit being adapted to provide electricity to at least a body builder electrical equipment and comprising an equipment battery set comprising at least an equipment battery;
an equipment battery set sensor adapted to provide at least a state of charge of the equipment battery set;
an equipment converter which interconnects the equipment circuit and the driving circuit, and which is adapted at least to transfer electrical energy from the driving circuit to the equipment circuit;
a body builder interface and controller which controls at least the equipment converter so as to provide energy to the equipment circuit according to at least the state of the drive system as provided by the drive system control unit.
   The implementation of an equipment circuit with an equipment battery dedicated to the power supply to the bodybuilder equipment, such power supply being controlled by the body builder interface and controller allows to fine tune the use of the available energy in order to reduce the fuel consumption.

According to an aspect of the invention, the body builder interface and controller controls the driving and equipment converters according also to the state of charge of the equipment battery set.

By taking into consideration the state of charge of the equipment battery set, it is possible to adjust the state of charge of both the driving battery set and the equipment battery set so that, for example, any of those is always available for accumulating the electric power recovered during slowing down phases of the movement of the hybrid vehicle.

According to another aspect of the invention, the drive system electronic control unit is adapted to:
determine a level of power available from the engine unit and/or the motor system;
and/or determine a level of energy cost;
   and the body builder interface and controller is adapted to:
determine a level of output power for the equipment converter, according to the level of cost of energy and/or to the level of power available; and
set the output power of the equipment converter at the determined level of output power.

According to the invention, the above determination can be conducted in several ways. For example, the cost of energy can comprise at least two levels corresponding to energy being free or of very low cost and to energy being very expensive. The energy free level will correspond for example to braking phases or slowing down phases of the vehicle, with the driving battery set highly charged. In such conditions there is plenty of electricity to be used, which cannot be stored in the driving battery set. The energy very expensive level will correspond for example to phases during which the vehicle is electrically driven, or during which the electric drive system provides torque-assist to the engine system, or during which the state of charge of the driving battery is too low. Of course, the cost of energy information provided by the drive system control unit may comprises more levels of energy cost allowing to take into consideration more accurately the various functioning phases of the drive system.

Furthermore the body builder interface and controller may be adapted to set the output level of the equipment converter according to a power required by a body builder equipment as provided to the body builder interface and controller or determined by the body builder interface and controller. The body builder interface and controller may also be adapted to set the output level of the equipment converter according to information of faulty component either in the drive system or in the body builder equipment.

According to another aspect of the invention, the equipment circuit comprises an electrical converter with an off-board plug for deriving electrical energy from an external network.

The implementation of such electrical converter with an off-board plug is more particularly useful for hybrid vehicles having short periods of use compared to parking period during which the hybrid vehicles stay still in their garage such as, for example, for refuse vehicles or emergency vehicles.

According to another aspect of the invention, the body builder interface and controller is adapted to be connected to the body builder equipment system and to control the equipment converter according to the state of the body builder equipment system

The implementation of such bodybuilder interface facilitates the work of the bodybuilder while installing the equipment on the vehicle.

The control achieved by the body builder interface and controller may be done in several ways depending for example on the type of the bodybuilder equipment but also of several other different parameters. For example, the body builder interface and controller and the drive system control unit might be adapted to give priority to providing energy to the driving system when the vehicle is moving.

The body builder interface and controller might also be adapted to give priority to providing power to the equipment circuit when the body builder equipment system is working.

According to an aspect of the invention, the equipment circuit may provide electrical power to any kind of bodybuilder equipment. According to an embodiment of an aspect of the invention adapted for replacing a mechanical power take-off on the driveline or on the internal combustion engine, the equipment circuit comprises an equipment electric motor adapted for providing mechanical energy to a body builder equipment system.

According to an aspect of this embodiment, the equipment circuit comprises a dedicated electronic power converter interposed between the equipment circuit and the equipment electric motor, the dedicated electronic power converter being adapted to adjust the torque and/or the speed output of the equipment electric motor.

When the equipment electric motor is used to drive a hydraulic pump, the high dynamic regulation allowed by the dedicated electronic power converter with the high speed capability of the equipment electric motor allows the bodybuilder to use a constant flow hydraulic pump and to adjust the flow by the way of the dedicated electronic power converter. As the cost of a constant flow hydraulic pump is significantly lower than the cost of an adjustable flow hydraulic pump, this allows to reduce the total cost of the bodybuilder equipment system.

According to another aspect of this embodiment, allowing many possibilities for the bodybuilder, the body builder interface and controller is adapted to control the dedicated electronic converter.

According to an aspect of the invention, the various battery sets of the hybrid vehicle may be of various types provided they are perfectly adapted to their specific use.

According to a preferred form of implementation of an aspect of the invention:
the service battery set is of a low nominal voltage, preferably being in the range of 12 V to 72 V
the equipment battery set is of a medium nominal voltage, preferably being in the range of 84 V to 810 V
the driving battery set is of a high nominal voltage or of a medium nominal voltage, preferably being in the range of 120 V to 1000 V.

According to an aspect of the invention:
each service battery is a battery optimized for deep cyclic uses and for total energy capacity or a battery of a dual type being a compromise between an energy battery and a power battery.
each driving battery is a battery with a low internal resistance optimized for efficient low duration high current output; and
each equipment battery is a battery optimized for deep cyclic uses and for total energy capacity or a battery with a low or medium internal resistance optimized for efficient low or medium duration high current output.

The various above aspects, embodiments or objects of the invention may be combined in various ways with each others, provided the combined aspects, embodiments or objects are not incompatible or mutually exclusive.

Other aspects and advantages of the present invention will be apparent from the following detailed description made in conjunction with the accompanying drawing illustrating schematically some non-limitative embodiments of the invention.

### BRIEF DESCRIPTION OF THE DRAWINGS

FIG. 1 is a schematic view of a hybrid vehicle according to the invention.

FIG. 2 is another embodiment of a hybrid vehicle according to the invention which differs from the embodiment shown on FIG. 1 by the implementation of a bodybuilder interface.

FIG. 3 is a schematic view of still another embodiment of hybrid vehicle according to the invention which differs from the embodiment shown on FIG. 2 by the implementation of a dedicated electronic power converter used for supplying power to an equipment electric motor

Corresponding reference numbers indicate corresponding components in the various embodiments illustrated in the drawings.

### DETAILED DESCRIPTION

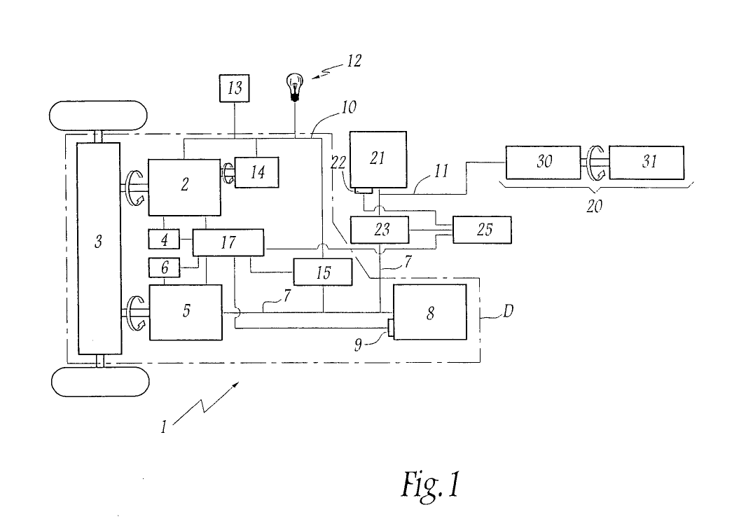

As illustrated on FIG. 1, a hybrid vehicle, designated as a whole by reference 1, comprises a drive system D which includes an internal combustion engine unit 2 powering a mechanical driveline 3. The internal combustion engine unit 2 is associated with an engine electronic control unit 4 providing at least a state of the engine unit 2 to a drive system control unit 17. The drive system D comprises also an electric drive motor system 5 which is as well operatively connected to the driveline 3. The electric drive motor system is associated with a motor electronic control unit 6 connected to the drive system control unit 17. The mechanical driveline can be of different types such as a parallel or series type or a planetary gear type. In the same manner the electric drive motor system 5 may comprise a single electric motor or a plurality of electric motors combined with a single electric generator or a plurality of electric generator in order to recover during slowing down phases of the hybrid vehicle. As the electric motor and the electric generator may be mutually separate, they also can be combined as a single motor/generator which selectively functions as an electric motor or an electric generator.

The hybrid vehicle 1 comprises a driving circuit 7 which provides electricity at least to the electric drive motor system 5 and which comprises a driving battery set 8 comprising at least one driving battery not shown. The driving battery set 8 may of course comprise a plurality of driving batteries either connected in series or in parallel depending on capacity or the nominal voltage of the driving battery set. The driving battery set is preferably of a medium or a high nominal voltage, for example being in the range of 120 V to 1000 V. Furthermore, each driving battery is preferably a battery with a low internal resistance optimized for efficient low duration high current output. In order to monitor the functioning of the driving battery set 8, the hybrid vehicle 1 comprises driving battery set sensor 9 adapted to provide at least the state of charge of the driving battery set 8 to the drive system control unit 17. The hybrid vehicle 1 also comprises a service circuit 10 as well as an equipment circuit 11. The service circuit 10 provides electricity at least to the engine unit 2 but also to other electrical consumers 12 schematically depicted as a light bulb on the figures. The service circuit 10 comprises a service battery set 13 which comprises at least one service battery not individually shown on the figures. The service battery set 13 is of a low nominal voltage, for example being in the range of 12 V to 72 V. Each service battery is preferably a battery optimized for deep cyclic uses and for total energy capacity but can also be of a dual type being a compromise between an energy battery and a power battery. The service circuit 10 further comprises an electric generator operatively connected to the engine unit 2 and therefore driven by internal combustion engine unit 2. The service circuit 10 is also connected to the driving circuit 7 through a driving converter 15, the driving converter 15 mainly works a step-down converter lowering voltage of the driving circuit 10 in order to provide electricity to the service circuit 7 and more particularly in order to charge the service battery set 8. The driving converter 15 can also be of a step-up/step-down type in order to reciprocally derive power from the service circuit 10 for providing electricity to the driving circuit 7.

The equipment circuit 11 is adapted to provide electricity to at least a bodybuilder electrical equipment 20 in an autonomous manner and therefore comprises an equipment battery set 21 being constituted by at least one service battery and generally more than one equipment battery depending on the nominal voltage of the equipment battery set 21. Preferably, the equipment battery set is of a medium nominal voltage being for example in the range of 84 V to 810 V. Each equipment battery is either a battery with a low or medium internal resistance optimized for efficient low or medium duration high current output or a battery optimized for deep cyclic uses and total energy capacity depending on the type of equipment implemented by the bodybuilder. All the batteries of the equipment battery set are naturally of the same type. The hybrid vehicle 1 comprises equipment battery set sensor 22 adapted for providing a step of charge of the equipment battery set 21. The equipment circuit 11 is connected to the driving circuit 7 through an equipment converter 23 which is adapted to step-down the voltage of the driving circuit 7 in order to provide electricity to the equipment circuit 11. The equipment converter 23 may also be of step-up/step-down type in order to reciprocally derive energy from the equipment circuit 11 for charging the driving battery set 8 or powering the electric motor unit 5. In order to optimize the repartition of the energy during slowing phases of the hybrid vehicle as well as the repartition of the electric power provided by the electric generator 14 when the internal combustion engine 2 is running, the hybrid vehicle 1 further comprises a body builder interface and controller 25 which comprises electronic communication and control equipment and may also comprise a physical interface for the body builder to connect for example a equipment system control unit. The body builder interface and controller 25 controls the equipment converter 23 so as to provide energy to the equipment circuit 11. In order to achieve this, the body builder interface and controller 25 is connected to the two converters 15, 23 as well as to the equipment battery set sensor 22. The body builder interface and controller 25 is also connected to the drive system control unit 17. The connection between the body builder interface and controller 5 and these various elements can be direct wire connection as shown, or implement a Controller Area Network (CAN) well-known by the man skilled in the art. In order to optimize the repartition of the electric power available, the body builder interface and controller 25 controls the equipment 23 converter according at least to the state of the drive system D. More preferably, the body builder interface and controller 25 will also take into consideration the state of charge of the equipment battery set 21. This control can be conducted in various ways. According to a preferred embodiment, the body builder interface and controller 25 and/or the engine electronic control unit 4 and/or the motor electronic control unit 6 drive system control unit 17 are adapted to:
determine a level of power available from the drive system D;
determine a level of energy cost;
determine a level of output power for the equipment converter 23, according to the level of cost of energy and the level of power available; and
set the output power of the equipment converter at the determined level of output power.

For example, when the hybrid vehicle is in a slowing down movement and the driving battery set 8 is completely or sufficiently charged, the energy available is determined as totally free. Therefore the body builder interface and controller 25 will set the equipment converter 23 at its full power if the equipment battery set 21 is at a low state of charge. When the state of charge of the driving battery set 8 is on an intermediate level and the vehicle is slowing down, the drive system control unit 17 will provide a medium energy cost level to the body builder interface and controller 25. If the state of charge of the equipment battery 21 is at an intermediate level or low level, the body builder interface and controller 25 will thus determine the power available for the equipment circuit as being intermediate and will set the output power of the equipment converter 23 at an intermediate level. Therefore, only a part of the electrical energy available will be derived to the equipment circuit 11, the other part being used for charging the driving battery set 8. In the same manner, if the state of charge of the driving battery set 8 is at a very low level, the drive system control unit 17 will provide a high energy cost level. If the state of charge of the equipment battery set 21 is not too low, the body builder interface and controller 25 will therefore determine, the level of the output power of the equipment converter 23 to be zero. Accordingly, the equipment converter 23 will be stopped so that all the electrical energy available will be used for charging the driving battery set 8 and the equipment 20 will run on the equipment battery set 21. Nevertheless if the energy cost level is high but the state of charge of the equipment battery set 21 is low while there is a need of power at the equipment system end, the body builder interface and controller 25 may, in order to keep a continuity of service, set the output of the equipment converter 23 at the level adapted for the equipment system to run correctly.

The implementation of the battery equipment 7 and the equipment converter 23 in combination with the body builder interface and controller 25 connected to the drive system control unit 17 allows a fine tuning of the charging of both the equipment battery set 21 and the driving battery set 8 in order to make sure that all the energy recovered during regenerative braking can be absorbed by either the driving battery set 8 and the equipment battery set 21 without any risk of damaging any of the battery sets, their state of charge being constantly monitored by their respective sensing means.

According to the invention, the bodybuilder electrical equipment 20 can be of various types. On the shown embodiments, the bodybuilder electrical equipment comprises an equipment electric motor 30 adapted for providing mechanical energy to a bodybuilder equipment system 31 and for example, the equipment electric motor 30 to drive a hydraulic pump.

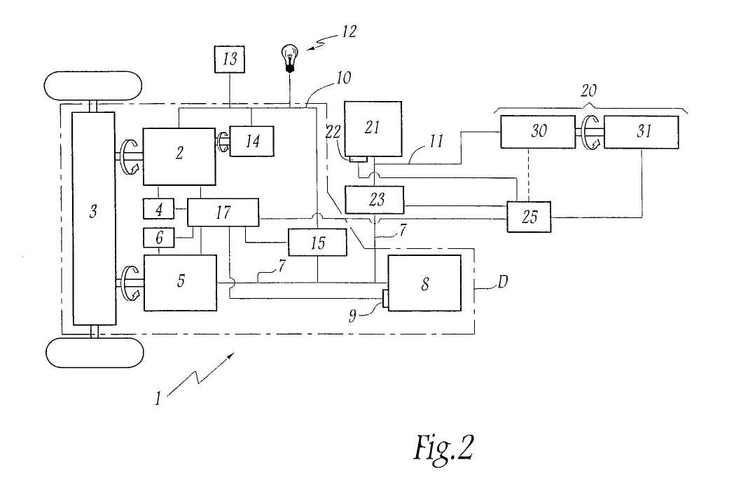

On the embodiment depicted at FIG. 2, the bodybuilder system 31 is connected to the body builder interface and controller 25 so that it can control the functioning of the equipment converter 23 also according to a state of the bodybuilder equipment system 31. The body builder interface and controller 25 can also be optionally connected to the equipment electric motor 30 so as to control its functioning according to the bodybuilder equipment's 31 state or needs. As for the electric motor unit 5, the equipment electric motor 30 can be of the motor/generator type in order to recover electrical energy from the bodybuilder equipment system 31.

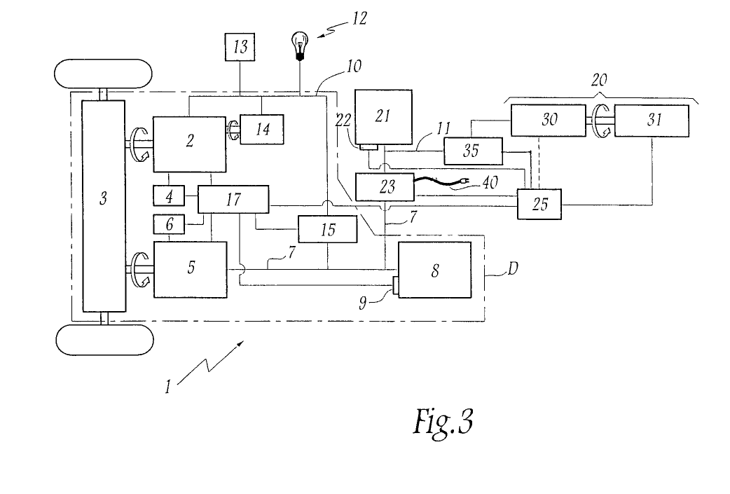

According to the embodiment shown on FIG. 3, the hybrid vehicle 1 further comprises a dedicated electronic power converter 35 which is interposed between the equipment circuit 11 and the equipment electric motor 30. The dedicated electronic power converter 35 is adapted to adjust the torque and/or the speed output of the equipment electric motor 30 according to the needs of the bodybuilder equipment system 31. Therefore, the dedicated electronic power converter 35 is controlled by the body builder interface and controller 25 to which it is connected directly or via a controller area network (CAN). The body builder interface and controller 25 may control the functioning of the equipment converter 23 so as to give priority to providing energy to the driving battery set when the vehicle is moving, meaning
shutting down the equipment converter 23 when the state of charge of the driving battery is low;
setting the output of the equipment converter 23 at a medium power when the state of charge of the driving battery set 8 is at an intermediate level and
setting the output power of the equipment battery set 23 at a full power when the state of charge of the driving battery set 8 is high.

On the other hand, the body builder interface and controller 25 can also be adapted to give priority to provide power to the equipment circuit when the bodybuilder equipment is working which means when state of charge of the equipment battery 21 is low, to have the equipment converter 23 working at its full power and if the internal combustion engine unit 2 is running, the driving converter 15 will be also working at full power. On the example shown FIG. 3, the converter 23 further comprises an off-board plug 40 and is adapted for deriving electrical energy from an external network.

Of course, many other types of suitable settings or priorities may be implemented by the body builder interface and controller 25.

In the shown embodiments the engine electronic control unit 4 and the motor electronic control unit 6 are two independent units, but these can be embedded in a same electronic control unit or being parts of the drive system control unit 17 controlling the drive functions and units of the vehicle. While the invention has been shown and described with reference to certain embodiments thereof, it would be understood by those skilled in the art that changes in form and details may be made therein without departing from the spirit and scope of the invention as defined in the amended claims.

1. Hybrid vehicle comprising:
a drive system comprising at least:
an internal combustion engine unit;
an electric motor system which is connected to a driving circuit comprising a driving battery set which comprises at least one driving battery;
a service circuit providing electricity at least to the engine unit, the service circuit comprising a service battery set which comprises at least one service battery;
a drive system control unit providing at least a state of the drive system;
an equipment circuit being adapted to provide electricity to at least a body builder electrical equipment and comprising an equipment battery set comprising at least an equipment battery;
an equipment battery set sensor adapted to provide at least a state of charge of the equipment battery set;
an equipment converter which interconnects the equipment circuit and the driving circuit, and which is adapted at least to transfer electrical energy from the driving circuit to the equipment circuit;
a body builder interface and controller which controls at least the equipment converter so as to provide energy to the equipment circuit according to at least the state of the drive system as provided by the drive system control unit.

2. Hybrid vehicle according to claim 1, wherein the body builder interface and controller controls the equipment converter according also to the state of charge of the equipment battery set.

3. Hybrid vehicle according to claim 1, wherein the drive system electronic control unit is adapted to:
determine a level of power available from the engine unit and/or the electric motor system;
and/or determine a level of energy cost;
and the body builder interface and controller is adapted to:
determine a level of output power for the equipment converter, according to the level of cost of energy and/or to the level of power available; and
set the output power of the equipment converter at the determined level of output power.

4. Hybrid vehicle according to claim 1, wherein the equipment circuit comprises an electrical converter with an off-board plug for deriving electrical energy from an external network.

5. Hybrid vehicle according to claim 1, wherein the body builder interface and controller is adapted to control the equipment converter according also to information provided by the body builder equipment.

6. Hybrid vehicle according to claim 1, wherein the equipment circuit comprises an equipment electric motor adapted for providing mechanical energy to a body builder equipment system (31).

7. Hybrid vehicle according to claim 6, wherein the body builder interface and controller is adapted to control the equipment converter according to the state of the body builder equipment system.

8. Hybrid vehicle according to claim 7, wherein the drive system control unit is adapted to give a high cost of energy to the body builder interface and controller when the vehicle is moving.

9. Hybrid vehicle according to claim 7, wherein the body builder interface and controller is adapted to give priority to providing power to the equipment circuit when the body builder equipment system is working.

10. Hybrid vehicle according to claim 6, wherein the equipment circuit comprises a dedicated electronic power converter interposed between the equipment circuit and the equipment electric motor, the dedicated electronic power converter being adapted to adjust the torque and/or the speed output of the equipment electric motor.

11. Hybrid vehicle according to claim 10, wherein the body builder interface is adapted to control the dedicated electronic converter.

12. Hybrid vehicle according to claim 1, wherein:
the service battery set is of a low nominal voltage, preferably being in the range of 12 V to 72 V
the equipment battery set is of a medium nominal voltage, preferably being in the range of 84 V to 810 V
the driving battery set is of a high nominal voltage or of a medium nominal voltage, preferably being in the range of 120 V to 1000 V.

13. Hybrid vehicle according to claim 1, wherein:
each service battery is a battery optimized for deep cyclic uses and for total energy capacity or a battery of a dual type being a compromise between an energy battery and a power battery.
each driving battery is a battery with a low internal resistance optimized for efficient low duration high current output; and
each equipment battery is a battery optimized for deep cyclic uses and for total energy capacity or a battery with a low or medium internal resistance optimized for efficient low or medium duration high current output.
